(19) United States
(12) Patent Application Publication
(10) Pub. No.: US 2012/0108285 A1
(43) Pub. Date: May 3, 2012

(54) RADIO COMMUNICATION SYSTEM, RADIO BASE STATION, AND RADIO COMMUNICATION METHOD

(75) Inventor: Chiharu Yamazaki, Kanagawa (JP)

(73) Assignee: KYOCERA CORPORATION, Kyoto (JP)

(21) Appl. No.: 13/379,559

(22) PCT Filed: Jun. 25, 2010
(86) PCT No.: PCT/JP2010/060908

§ 371 Date: Dec. 20, 2011

(30) Foreign Application Priority Data
Jun. 25, 2009 (JP) 2009-151662

(51) Int. Cl. H04W 72/04; H04W 52/04

(52) U.S. Cl. 455/509

(57) ABSTRACT

A radio communication system (1) wherein a radio base station (BS1), which allocates to a radio terminal (UE1) a radio resource specified by the combination of a frequency and a time, and a radio base station (BS2), which allocates to the radio terminal (UE1) the same radio resource, use this radio resource to perform a cooperative communication with the radio terminal (UE1). In the radio communication system (1), if a predetermined condition, which indicates that the contribution of the radio base station (BS1) to the cooperative communication is lower than a predetermined degree, is satisfied and further if a propagation path quality (Q2) between the radio base station (BS1) and a radio terminal (UE2) is better than a propagation path quality (Q1) between the radio base station (BS1) and the radio terminal (UE1), then the radio base station (BS1) allocates the foregoing radio resource to the radio terminal (UE2) instead of the radio terminal (UE1).

### TECHNICAL FIELD

The present invention relates to a radio communication system in which multiple radio base stations communicate with a single radio terminal while using the same radio resource, and also relates to a radio base station and a radio communication method.

### BACKGROUND ART

One of known conventional techniques capable of improving the frequency usage efficiency in a radio communication system is MIMO (Multi-Input Multi-Output) communications in which a transmission side transmits and a reception side receives radio signals by using the same radio resource (combination of frequency and time) while each using multiple antennas.

In recent years, coordinated MIMO communications (hereinafter, referred to as “coordinated communications” as needed) have been attracting attention as an advanced technique of MIMO communications. In the coordinated communications, multiple radio base stations make use of communications between the base stations to communicate with a single radio terminal by using the same radio resource (refer to Patent Document 1, for example).

The 3GPP (3rd Generation Partnership Project), which is a standardization project for radio communication systems, has termed the above described coordinated communications CoMP (Coordinated Multipoint transmission/reception), and has been making discussion on the formulation of the specification of CoMP.

The scheme of CoMP mainly includes two types, which are a JP (Joint Processing) scheme and a CS (Coordinated Scheduling) scheme.

The JP scheme is a coordinated communication scheme in which multiple radio base stations communicate with a radio terminal at the same time. A first radio base station and a second radio base station perform data transmission to a single radio terminal by using the same radio resource, for example.

The CS scheme is a coordinated communication scheme in which a radio base station having a high channel quality with a radio terminal among multiple radio base stations communicates with the radio terminal. The CS scheme is a scheme in which any one of the first radio base station and the second radio base station, both using the same radio resource, is selected and performs data transmission to the radio terminal, for example.

### PRIOR ART DOCUMENT

### Patent Document

PATENT DOCUMENT 1: Published Japanese Translation of PCT International Application No. 2008-523665

### SUMMARY OF THE INVENTION

The coordinated communications (COMP) can improve the communication performance as compared with normal MIMO communications, but achieves lower frequency usage efficiency than the normal MIMO communications because the radio resource is consumed by both of the first radio base station and the second radio base station. Furthermore, the coordinated communications have the following problem.

In the coordinated communications of the JP scheme, if the channel quality between the first radio base station and the radio terminal is significantly lower than the channel quality between the second radio base station and the radio terminal, the first radio base station does not make much contribution to the coordinated communications. Thus, the problem in this case is that the radio resource used in the coordinated communications by the first radio base station is wastefully consumed.

In particular, in a case where the communications between the base stations are performed at a relatively low speed, a scheme of fixedly allocating the radio resource used in coordinated communications is more appropriate than a scheme of dynamically changing the radio resource. In the former case, the difference between the channel qualities as described above easily occurs.

Meanwhile, in the coordinated communications of the CS scheme, the first radio base station does not make any contribution to the coordinated communications during a period when the second radio base station communicates with the radio terminal and the first radio base station does not communicate with the radio terminal. Thus, there arises a problem that the radio resource used in the coordinated communications by the first radio base station is wastefully consumed.

In this respect, an object of the present invention is to provide a radio communication system, a radio base station and a radio communication method each of which achieves effective utilization for a radio resource used in coordinated communications.

The present invention has the following features to solve the problems described above. First of all, a first feature of the present invention is summarized as a radio communication system (radio communication system 1) comprising: a first radio terminal (radio terminal UE1); a second radio terminal (radio terminal UE2); a first radio base station (radio base station BS1) configured to allocate, to the first radio terminal, a radio resource specified by a combination of frequency and time; and a second radio base station (radio base station BS2) configured to allocate, to the first radio terminal, the same radio resource as the radio resource, wherein the first radio base station and the second radio base station perform coordinated communications (COMP) with the first radio terminal by using the radio resource, and the first radio base station allocates the radio resource to the second radio terminal instead of the first radio terminal if a predetermined condition indicating that contribution of the first radio base station to the coordinated communications is lower than a predetermined degree is satisfied and also if a second channel quality (channel quality Q2) between the first radio base station and the second radio terminal is higher than a first channel quality (channel quality Q1) between the first radio base station and the first radio terminal.

According to the aforementioned feature, the first radio base station allocates the radio resource used in coordinated communications to the second radio terminal instead of the first radio terminal if the contribution of the first radio base station to the coordinated communications is lower than a predetermined degree and also if the second channel quality is higher than the first channel quality. Thus, the radio resource can be effectively utilized.

Note that, if the first radio base station allocates the radio resource to the second radio terminal, the first radio terminal cannot perform communications with the first radio base station temporarily, but such a situation does not become a problem because the first radio base station does not make any contribution to the coordinated communications in the first place, and the second radio base station can communicate with the first radio terminal.

A second feature of the present invention is summarized as a radio base station (radio base station BS1) comprising a resource allocation unit (resource allocation unit 121) configured to allocate a radio resource specified by a combination of frequency and time to a radio terminal (radio terminal UE1), the radio base station configured to perform coordinated communications with the radio terminal together with a different radio base station (radio base station BS2) configured to allocate the same radio resource as the radio resource to the radio terminal, wherein the resource allocation unit allocates the radio resource to a different radio terminal (radio terminal UE2) instead of the radio terminal if a predetermined condition indicating that contribution of the radio base station to the coordinated communications is lower than a predetermined degree is satisfied and also if a second channel quality (channel quality Q2) between the radio base station and the different radio terminal is higher than a first channel quality (channel quality Q1) between the radio base station and the radio terminal.

In the aforementioned feature of the present invention, the predetermined condition may be that the first channel quality is lower than a third channel quality (channel quality Q3) between the different radio base station and the radio terminal.

In the aforementioned feature of the present invention, the predetermined condition may be that the first channel quality is lower than the third channel quality while a difference between the first channel quality and the third channel quality is equal to or greater than a predetermined value (Q1<<Q3).

In the aforementioned feature of the present invention, the predetermined condition may be that the radio base station is not selected in the coordinated communications using a scheme (CS scheme) in which any selected one of the radio base station and the different radio base station performs data transmission to the radio terminal.

In the aforementioned feature of the present invention, the predetermined condition may be a condition that there is no data to be transmitted and received by the radio base station to and from the radio terminal.

In the aforementioned feature of the present invention, the resource allocation unit may allocate the radio resource to the radio terminal again if the predetermined condition is no longer satisfied.

In the aforementioned feature of the present invention, the radio base station may further comprise a transmitter (transceiver 110) configured to perform data transmission by using the radio resource; and a transmission power controller (transmission power controller 124) configured to control a transmission power for data transmission performed by the transmitter, wherein the resource allocation unit allocates the radio resource to the different radio terminal instead of the radio terminal if the predetermined condition is satisfied, if the second channel quality is higher than the first channel quality, and also if a difference between the first channel quality and the second channel quality is equal to or greater than a predetermined value (Q1<<Q2), and the transmission power controller reduces a transmission power for data transmission to the different radio terminal below a transmission power for data transmission to the radio terminal if the resource allocation unit allocates the radio resource to the different radio terminal instead of the radio terminal.

In the aforementioned feature of the present invention, the resource allocation unit may allocate the radio resource to the different radio terminal instead of the radio terminal without taking a procedure to cancel the coordinated communications if the predetermined condition is satisfied and also if the second channel quality is higher than the first channel quality.

A third feature of the present invention is summarized as a radio communication method comprising the steps of: allocating a radio resource specified by a combination of frequency and time to a first radio terminal by a first radio base station; allocating the same radio resource as the radio resource to the first radio terminal by a second radio base station; performing coordinated communications with the first radio terminal by using the radio resource by the first radio base station and the second radio base station; and allocating the radio resource to the second radio terminal instead of the first radio terminal by the first radio base station if a predetermined condition indicating that contribution of the first radio base station to the coordinated communications is lower than a predetermined degree is satisfied and also if a second channel quality between the first radio base station and the second radio terminal is higher than a first channel quality between the first radio base station and the first radio terminal.

According to the features of the present invention, it is possible to provide the radio communication system, the radio base station and the radio communication method each of which makes it possible to effectively utilize a radio resource used in coordinated communications.

### BRIEF DESCRIPTION OF THE DRAWINGS

FIG. 1 is a schematic configuration diagram of a radio communication system according to an embodiment of the present invention.

FIG. 2 is a block diagram showing a configuration of a radio base station according to the embodiment of the present invention.

FIG. 3 is a flowchart showing a schematic operation (COMP of the JP scheme) of the radio communication system according to the embodiment of the present invention.

FIG. 4 is a flowchart showing a schematic operation (COMP of the CS scheme) of the radio communication system according to the embodiment of the present invention.

FIG. 5 is a sequence diagram showing an operation sequence example 1 of the radio communication system according to the embodiment of the present invention.

FIG. 6 is a sequence diagram showing an operation sequence example 2 of the radio communication system according to the embodiment of the present invention.

FIG. 7 is a sequence diagram showing an operation sequence example 3 of the radio communication system according to the embodiment of the present invention.

FIG. 8 is a block diagram showing a configuration of a control device according to another embodiment.

### DESCRIPTION OF THE EMBODIMENTS

Next, a description will be given of embodiments of the present invention with reference to the drawings. To put it specifically, a description will be given of (1) Configuration of Radio Communication System, (2) Configuration of Radio Base Station, (3) Operation of Radio Communication System, (4) Effects of Embodiment and (5) Other Embodiments.

Note that, in the description of the drawings of the following embodiments, same or similar reference signs denote same or similar elements and portions.

### (1) CONFIGURATION OF RADIO COMMUNICATION SYSTEM

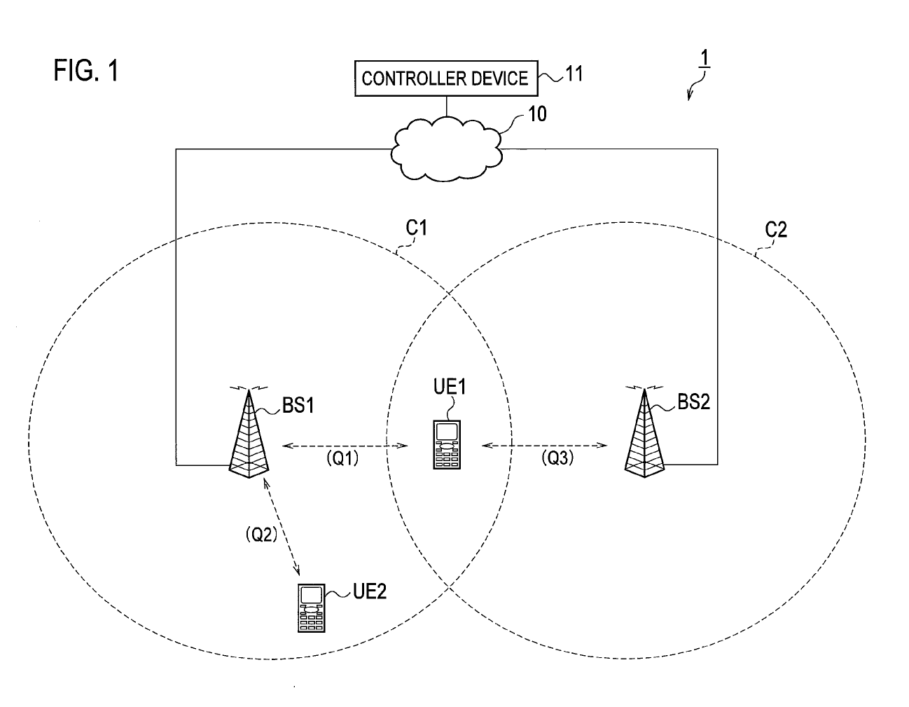

FIG. 1 is a schematic configuration diagram of a radio communication system 1 according to the present embodiment. The radio communication system 1 has a configuration based on LTE-Advanced, which is considered as the fourth generation (4G) cellular phone system, and supports CoMP (Coordinated Communications).

As shown in FIG. 1, the radio communication system 1 includes a radio base station BS1 (first radio base station), a radio base station BS2 (second radio base station), a radio terminal UE1 (first radio terminal), a radio terminal UE2 (second radio terminal) and a controller device 11.

The radio terminal UE1 is located in an overlapping portion of a cell C1, which is a communication area formed by the radio base station BS1, and a cell C2, which is a communication area formed by the radio base station BS2. The radio terminal UE2 is located within the cell C1.

The radio base station BS1, the radio base station BS2, the radio terminal UE1 and the radio terminal UE2 are each capable of periodically transmitting (broadcasting) a known signal that is a signal sequence known to the reception side (so called, a pilot signal). In addition, the radio base station BS1, the radio base station BS2, the radio terminal UE1 and the radio terminal UE2 are each capable of measuring channel qualities with the transmission side by using the received pilot signal. The channel qualities herein mean various parameters indicating the qualities of the radio channel such as the amounts of attenuation, phase rotation, and delay received by a signal passing through the radio channel. In the radio communication system 1, a channel quality Q1 between the radio base station BS1 and the radio terminal UE1, a channel quality Q2 between the radio base station BS1 and the radio terminal UE2, and a channel quality Q3 between the radio base station BS2 and the radio terminal UE1 are measured. Each of the channel qualities to be measured may be an instant channel quality or an average channel quality in a short period.

The radio base station BS1 and the radio base station BS2 are connected to each other via a backhaul network 10, which is a wired communication network. The controller device 11 is provided in the backhaul network 10 and controls the radio base station BS1 and the radio base station BS2 via the backhaul network 10. The radio base station BS1 and the radio base station BS2, however, are capable of directly performing communications between the base stations without the controller device 11 via a communication connection referred to as X2 interface.

The radio base station BS1 allocates a radio resource (hereinafter, a radio resource R1) specified by a combination of a frequency (subchannel) and time (time slot) to the radio terminal UE1. The radio resource R1 as described is referred to as a resource block (RB). The radio base station BS2 allocates the radio resource R1 to the radio terminal UE1. The radio base station BS1 and the radio base station BS2 perform. CoMP with the radio terminal UE1 by using the radio resource R1 allocated to the radio terminal UE1.

In CoMP of the JP scheme, the data transmitted by the radio base station BS1 using the radio resource R1 and the data transmitted by the radio base station BS2 using the radio resource R1 are basically the same data. To put it specifically, the reception quality in the radio terminal UE1 is improved by combining the data transmitted from the radio base station BS1 and the data transmitted from the radio base station BS2 by the radio terminal UE1.

In CoMP of the CS scheme, a selected one of the radio base station BS1 and the radio base station BS2 performs data transmission to the radio terminal UE1. If the channel quality Q1 is higher, the radio base station BS1 is selected, and when the channel quality Q3 is higher, the radio base station BS2 is selected. The data transmitted by the radio base station BS1 to the radio terminal UE1 by using the radio resource R1 and the data transmitted by the second radio base station to the radio terminal UE1 by using the radio resource R1 are basically different data. The selection of the radio base station to be selected is made by the controller device 11, for example.

### (2) CONFIGURATION OF RADIO BASE STATION

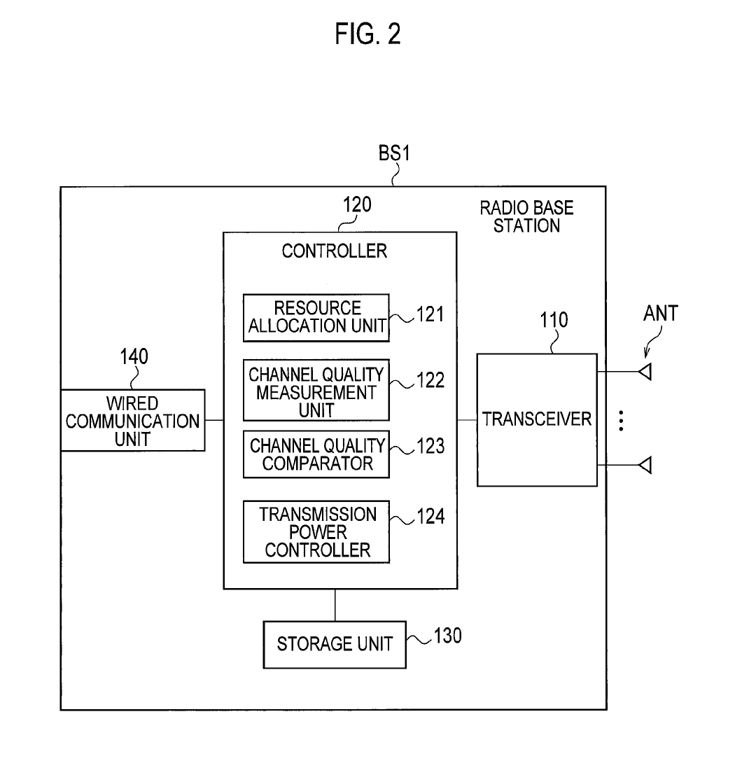

FIG. 2 is a block diagram showing a configuration of the radio base station BS1. As shown in FIG. 2, the radio base station BS1 includes antenna units ANT, a transceiver 110, a controller 120, a storage unit 130 and a wired communication unit 140.

The transceiver 110 is configured using an RF circuit, a BB circuit and the like, for example, and performs transmission and reception of a signal, as well as modulation/demodulation and coding/decoding or the like of a signal. The transceiver 110 forms a transmitter configured to perform data transmission by using the radio resource R1.

The controller 120 is configured using a CPU, for example, and controls various functions included in the radio base station BS1. The storage unit 130 is configured using a memory, for example, and stores therein various types of information used in control or the like of the radio base station BS1. The storage unit 130 functions as a transmission buffer configured to hold transmission data to be transmitted by the transceiver 110 until completion of the transmission. The controller 120 is capable of detecting whether or not transmission data is held in the storage unit 130. The wired communication unit 140 communicates with the radio base station BS2 and the controller device 11 via the backhaul network 10.

The controller 120 has a resource allocation unit 121, a channel quality measurement unit 122, a channel quality comparator 123 and a transmission power controller 124.

The resource allocation unit 121 allocates the radio resource R1 to the radio terminal UE1 when CoMP is performed with the radio terminal UE1.

The channel quality measurement unit 122 measures the channel quality Q1 by using a pilot signal 1 received from the radio terminal UE1 and also measures the channel quality Q2 by using a pilot signal 2 received from the radio terminal UE2.

The channel quality comparator 123 compares the channel quality Q1 and the channel quality Q2, which are measured by the channel quality measurement unit 122, and then compares a difference between the channel quality Q1 and the channel quality Q2 with a predetermined value.

The resource allocation unit 121 allocates the radio resource R1 to the radio terminal UE2 instead of the radio terminal UE1 if a predetermined condition indicating that contribution of the radio base station BS2 to CoMP is lower than a predetermined degree is satisfied, and also if the channel quality Q2 is higher than the channel quality Q1. The resource allocation unit 121 preferably allocates the radio resource R1 to the radio terminal UE2 instead of the radio terminal UE1 if the predetermined condition indicating that the contribution of the radio base station BS1 to CoMP is lower than the predetermined degree is satisfied and also if the channel quality Q2 is higher than the channel quality Q1 by a predetermined amount (threshold 1). Here, the allocation of the radio resource R1 to the radio terminal UE2 is performed without taking the procedure to cancel COMP.

Here, the predetermined condition is any one of (a) to (c) below, for example.
(a) In CoMP of the JP scheme, the channel quality Q1 is lower than the channel quality Q3 and also the difference between the channel quality Q1 and the channel quality Q3 is equal to or greater than a predetermined value (threshold 2). Note that, the lower limit of the threshold 2 may be set to a value of the channel quality Q3 of a case where the radio terminal UE1 can demodulate data by using a transmission signal from the radio base station BS2 alone.
(b) In CoMP of the CS scheme, the radio base station BS1 is not selected.
(c) In CoMP of the JP scheme or CS scheme, there is no transmission data to be transmitted to the radio terminal UE1 by the radio base station BS1 by using the radio resource R1.

The transmission power controller 124 controls a transmission power for data transmission performed by the transceiver 110. In a case where the resource allocation unit 121 allocates the radio resource R1 to the radio terminal UE2 instead of the radio terminal UE1, the transmission power controller 124 reduces the transmission power for data transmission to the radio terminal UE2 below the transmission power for data transmission to the radio terminal UE1.

The resource allocation unit 121 allocates the radio resource R1 to the radio terminal UE1 again if the predetermined condition described above is no longer satisfied after the radio resource R1 is allocated to the radio terminal UE2.

### (3) OPERATION OF RADIO COMMUNICATION SYSTEM

Next, a description will be given of an operation of the radio communication system 1 according to the first embodiment in the order of (3.1) Schematic Operation and (3.2) Operation Sequence Examples.

### (3.1) SCHEMATIC OPERATIONS

First, a description will be given of a schematic operation in CoMP of the JP scheme. Then, a description will be given of a schematic operation in CoMP of the CS scheme.

### (3.1.1) SCHEMATIC OPERATION IN CoMP OF JP SCHEME

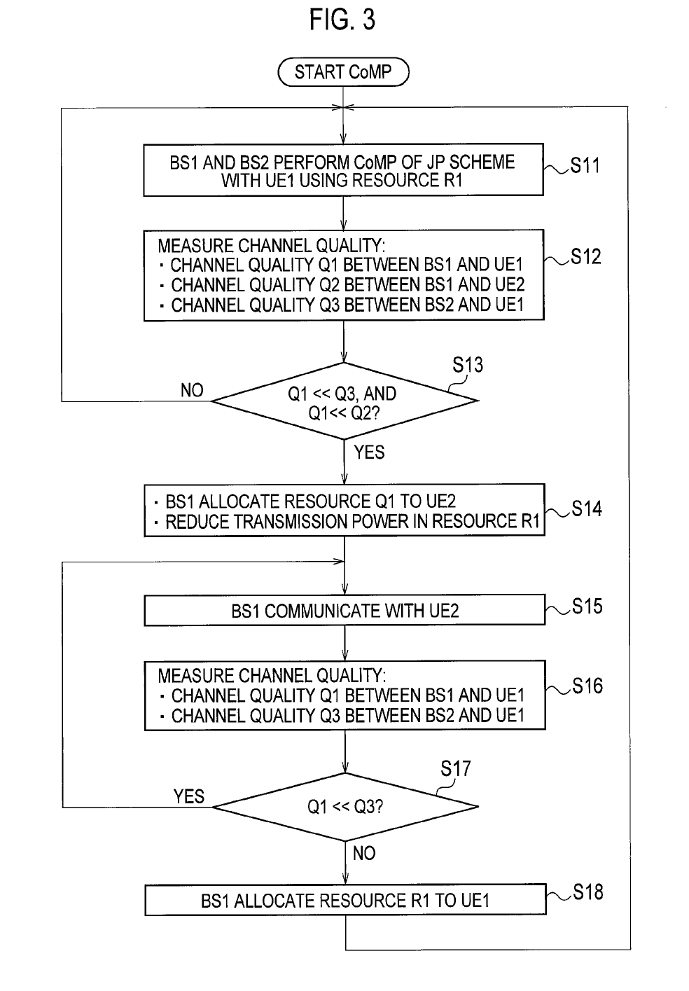

FIG. 3 is a flowchart showing a schematic operation of the radio communication system 1 in CoMP of the JP scheme. First, the controller device 11, the radio base station BS1, the radio base station BS2 and the radio terminal UE1 perform a setting procedure for starting CoMP. Here, an assumption is made that it is determined to use the radio resource R1 in CoMP in this setting procedure.

In step S11, the radio base station BS1 and the radio base station BS2 perform CoMP of the JP scheme with the radio terminal UE1 by using the radio resource R1.

In step S12, the radio base station BS1 or the radio terminal UE1 measures the channel quality Q1 between the radio base station BS1 and the radio terminal UE1. The radio base station BS1 or the radio terminal UE2 measures the channel quality Q2 between the radio base station BS1 and the radio terminal UE2. The radio base station BS2 or the radio terminal UE1 measures the channel quality Q3 between the radio base station BS2 and the radio terminal UE1.

In step S13, the radio base station BS1 compares the channel quality Q1 with the channel quality Q2 and also compares a difference between the channel quality Q1 and the channel quality Q2 with a predetermined value (threshold 1). The controller device 11 or the radio base station BS1 compares the channel quality Q1 with the channel quality Q3 and also compares a difference between the channel quality Q1 and the channel quality Q3 with a predetermined value (threshold 2).

If the channel quality Q1<the channel quality Q3 with the difference between the channel quality Q1 and the channel quality Q3 equal to or greater than the predetermined value (hereinafter, described as the channel quality Q1<<the channel quality Q3) and also if the channel quality Q1<the channel quality Q2 with the difference between the channel quality Q1 and the channel quality Q2 equal to or greater than the predetermined value (hereinafter, described as the channel quality Q1<<the channel quality Q2) (step S13; YES), the radio base station BS1 allocates the radio resource R1 to the radio terminal UE2 instead of the radio terminal UE1 in step S14. Meanwhile, if at least one of the channel quality Q1<<the channel quality Q3 and the channel quality Q1<<the channel quality Q2 is not satisfied (step S13; NO), the processing returns to step S11.

In step S15, the radio base station BS1 communicates with the radio terminal UE2 by using the radio resource R1 allocated to the radio terminal UE2.

In step S16, the radio base station BS1 or the radio terminal UE1 measures the channel quality Q1 between the radio base station BS1 and the radio terminal UE1. The radio base station BS2 or the radio terminal UE1 measures the channel quality Q3 between the radio base station BS2 and the radio terminal UE1.

In a case where the channel quality Q1 and the channel quality Q3 measured in step S16 no longer satisfies the condition that the channel quality Q1<<the channel quality Q3 (step S17; NO), the radio base station BS1 allocates the radio resource R1 to the radio terminal UE1 again in step S18. Meanwhile, if the condition that the channel quality Q1<<the channel quality Q3 is satisfied (step S17; YES), the processing returns to step S15.

Note that, a condition that “there is no transmission data to be transmitted to the radio terminal UE1 from the radio base station BS1” maybe used instead of the condition that the channel quality Q1<<the channel quality Q3 in steps S13 and S17.

### (3.1.2) SCHEMATIC OPERATION IN CoMP OF CS SCHEME

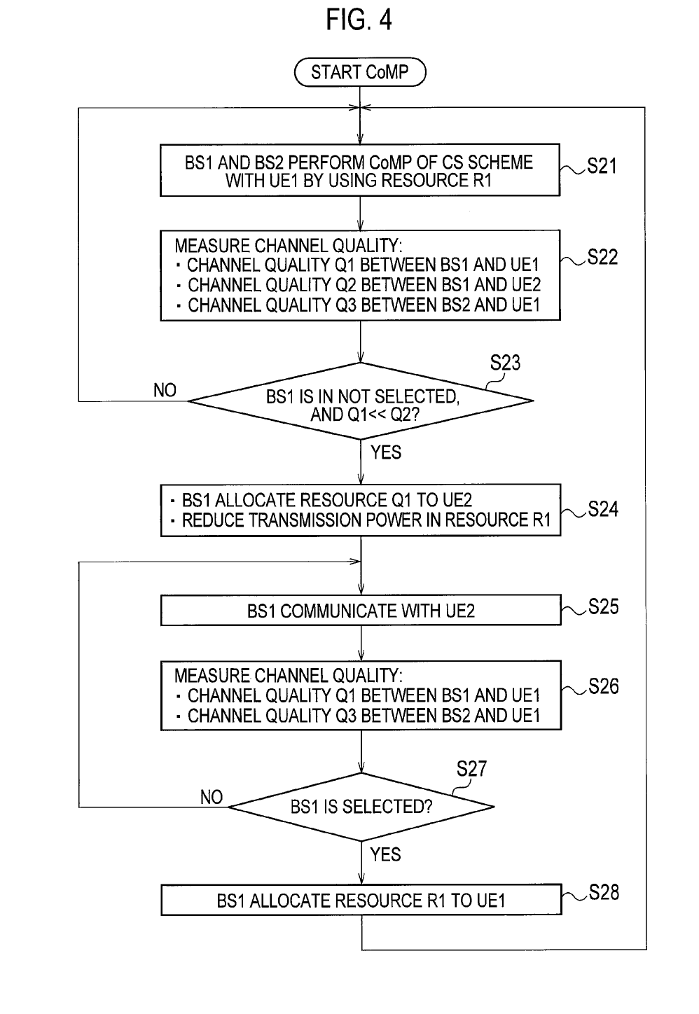

FIG. 4 is a flowchart showing a schematic operation of the radio communication system 1 in CoMP of the CS scheme.

The processing in steps S21 and S22 is executed in the same manner as in the case of steps S11 and S12 in FIG. 3.

In step S23, the controller device 11 or the radio base station BS1 compares the channel quality Q1 with the channel quality Q3. If the channel quality Q1 is higher, the radio base station BS1 is selected. If the channel quality Q3 is higher, the radio base station BS2 is selected. Moreover, the radio base station BS1 compares the channel quality Q1 with the channel quality Q2 and also compares a difference between the channel quality Q1 and the channel quality Q2 with a predetermined value.

If the radio base station BS1 is not selected and also if the condition that the channel quality Q1<<the channel quality Q2 holds true (step S23; YES), the radio base station BS1 allocates the radio resource R1 to the radio terminal UE2 instead of the radio terminal UE1 in step S24. In addition, the radio base station BS1 reduces the transmission power in the radio resource R1. Meanwhile, if at least one of the conditions that the radio base station BS1 is not selected and that the channel quality Q1<<the channel quality Q2 holds true is not satisfied (step S23; NO), the processing returns to step S21.

The processing in steps S24 to S26 is executed in the same manner as in the case of steps S14 to S16 in FIG. 3.

If the radio base station BS1 is selected on the basis of the channel quality Q1 and the channel quality Q3, which are measured in step S26 (step S27; YES), the radio base station BS1 allocates the radio resource R1 to the radio terminal UE1 again in step S28. Meanwhile, if the selected radio base station BS1 is kept selected on the basis of the channel quality Q1 and the channel quality Q3, which are measured in step S26 (step S27; NO), the processing returns to step S25.

Note that, the condition that “there is no transmission data to be transmitted to the radio terminal UE1 from the radio base station BS1” may be used instead of the condition that “the radio base station BS1 is not selected” in step S23. Moreover, a condition that “there is transmission data to be transmitted to the radio terminal UE1 from the radio base station BS1” may be used instead of the condition that “the radio base station BS1 is selected” in step S27.

### (3.2) OPERATION SEQUENCE EXAMPLES

Next, a description will be given of operation sequence examples 1 to 3 of the radio communication system 1. However, it is to be noted that each operation sequence to be described below is merely an example, and that various modifications are possible.

### (3.2.1) Operation Sequence Example 1

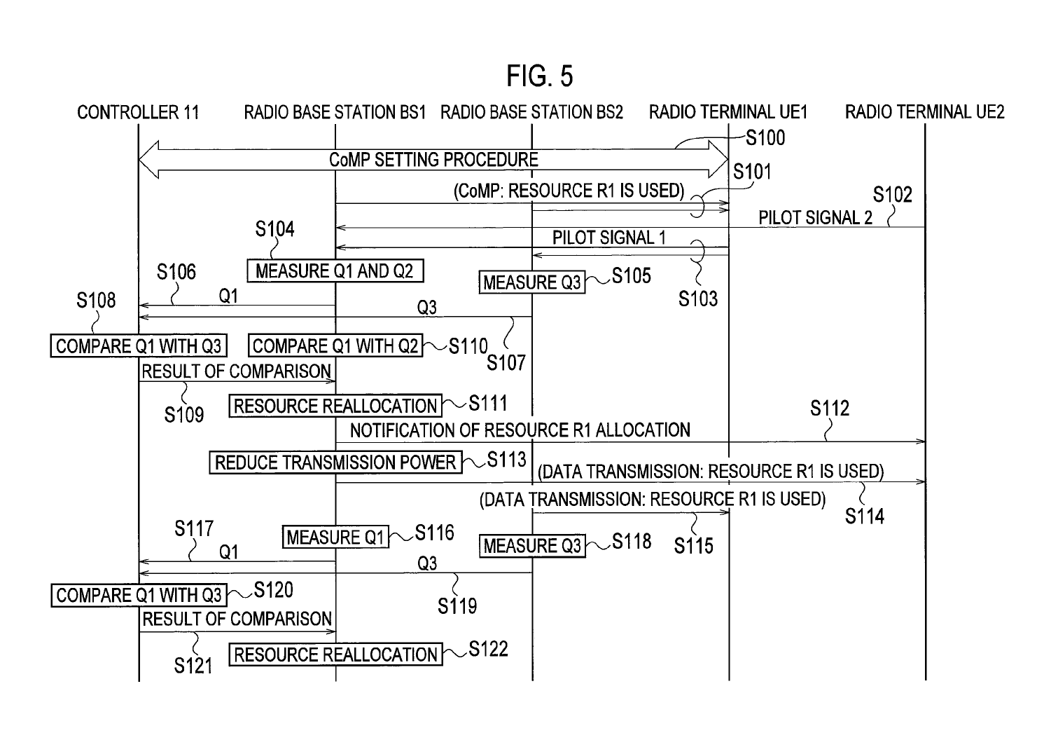

FIG. 5 is a sequence diagram showing an operation sequence example 1 of the radio communication system 1.

In step S100, the controller device 11, the radio base station BS1, the radio base station BS2 and the radio terminal UE1 perform a setting procedure for starting COMP.

In step S101, the radio base station BS1 and the radio base station BS2 perform CoMP with the radio terminal UE1 by using the radio resource R1.

In step S102, the radio terminal UE2 transmits a pilot signal 2. In step S103, the radio terminal UE1 transmits a pilot signal 1. Note that, each pilot signal is periodically transmitted thereafter.

In step S104, the channel quality measurement unit 122 of the radio base station BS1 measures the channel quality Q1 from the pilot signal 1 received from the radio terminal UE1 and also measures the channel quality Q2 from the pilot signal 2 received from the radio terminal UE2.

In step S105, the radio base station BS2 measures the channel quality Q3 from the pilot signal 1 received from the radio terminal UE1.

In step S106, the wired communication unit 140 of the radio base station BS1 transmits the channel quality Q1 measured by the channel quality measurement unit 122 in step S104 (or an index of the channel quality Q1) to the controller device 11.

In step S107, the radio base station BS2 transmits the channel quality Q3 measured in step S105 (or an index of the channel quality Q3) to the controller device 11.

In step S108, the controller device 11 compares the channel quality Q1 received from radio base station BS1 with the channel quality Q3 received from the radio base station BS2. In this operation example, an assumption is made that the result of the comparison shows that the channel quality Q1<<the channel quality Q3.

In step S109, the controller device 11 transmits information showing the result of the comparison between the channel quality Q1 and the channel quality Q3 to the radio base station BS1. In CoMP of the CS scheme, the information to be transmitted herein is not limited to the information showing the result of the comparison and may be information indicating that the radio base station BS1 is not selected.

In step S110, the channel quality comparator 123 of the radio base station BS1 compares the channel quality Q1 and the channel quality Q2, which are measured by the channel quality measurement unit 122. In this operation example, an assumption is made that the result of the comparison shows that the channel quality Q1<<the channel quality Q2.

In step S111, the resource allocation unit 121 of the radio base station BS1 allocates the radio resource R1 to the radio terminal UE2. During this processing, the procedure to cancel CoMP is omitted, and CoMP is kept set.

In step S112, the transceiver 110 of the radio base station BS1 transmits to the radio terminal UE2, an allocation notification indicating allocation of the radio resource R1.

In step S113, the transmission power controller 124 of the radio base station BS1 performs control to reduce the transmission power of the transmission signal using the radio resource R1.

In step S114, the transceiver 110 of the radio base station BS1 performs data transmission to the radio terminal UE2 by using the radio resource R1 allocated to the radio terminal UE2.

In step S115, the radio base station BS2 performs data transmission to the radio terminal UE1 by using the radio resource R1.

In step S116, the channel quality measurement unit 122 of the radio base station BS1 measures the channel quality Q1 again from the pilot signal 1 newly received from the radio terminal UE1.

In step S117, the wired communication unit 140 of the radio base station BS1 transmits the channel quality Q1 measured by the channel quality measurement unit 122 in step S116 (or an index of the channel quality Q1) to the controller device 11.

In step S118, the radio base station BS2 again measures the channel quality Q3 from the pilot signal 1 newly received from the radio terminal UE1.

In step S119, the radio base station BS2 transmits the channel quality Q3 measured in step S118 (or an index of the channel quality Q3) to the controller device 11.

In step S120, the controller device 11 compares the channel quality Q1 received from radio base station BS1 with the channel quality Q3 received from the radio base station BS2. In this operation example, an assumption is made that the result of the comparison shows that the channel quality Q1>the channel quality Q3.

In step S121, the controller device 11 transmits information showing the result of the comparison between the channel quality Q1 and the channel quality Q3 to the radio base station BS1. In CoMP of the CS scheme, the information to be transmitted herein is not limited to the information showing the result of the comparison and may be information indicating that the radio base station BS1 is selected.

In step S122, the resource allocation unit 121 of the radio base station BS1 allocates the radio resource R1 to the radio terminal UE1 again. During this processing, the procedure to cancel CoMP is omitted, and it is unnecessary to perform the setting procedure for resetting CoMP.

### (3.2.2) Operation Sequence Example 2

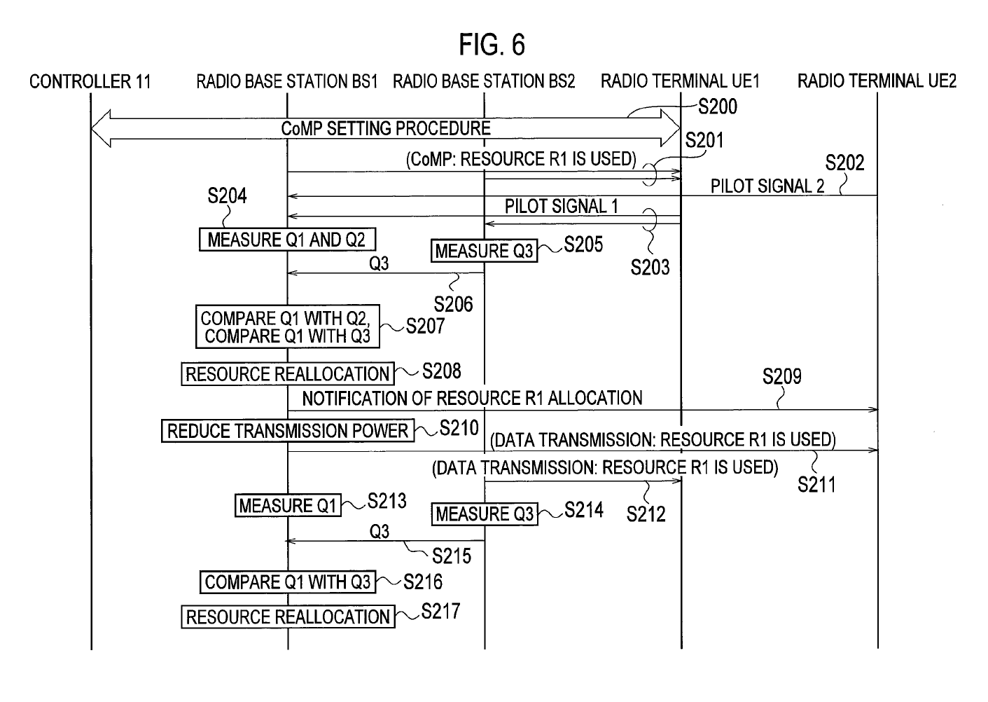

FIG. 6 is a sequence diagram showing an operation sequence example 2 of the radio communication system 1. While the controller device 11 performs the comparison between the channel quality Q1 and the channel quality Q3 in the operation sequence example 1 described above, the radio base station BS1 performs this comparison in this operation example.

The processing in steps S200 to S205 is executed in the same manner as in the case of steps S100 to S105 in the operation sequence example 1 described above.

In step S206, the radio base station BS2 transmits the channel quality Q3 measured in step S205 (or an index of the channel quality Q3) to the radio base station BS1 through the communications between the base stations.

In step S207, the channel quality comparator 123 of the radio base station BS1 compares the channel quality Q1 and the channel quality Q2, which are measured in step S204. In this operation example, an assumption is made that the result of the comparison shows that the channel quality Q1<<the channel quality Q2. Moreover, the channel quality comparator 123 compares the channel quality Q1 measured in step S204 with the channel quality Q3 received from the radio base station BS2 in step S206. In this operation example, an assumption is made that the result of the comparison shows that the channel quality Q1<<the channel quality Q3.

In step S208, the resource allocation unit 121 of the radio base station BS1 allocates the radio resource R1 to the radio terminal UE2. During this processing, the procedure to cancel CoMP is omitted, and CoMP is kept set.

In step S209, the transceiver 110 of the radio base station BS1 transmits to the radio terminal UE2, an allocation notification indicating allocation of the radio resource R1.

In step S210, the transmission power controller 124 of the radio base station BS1 performs control to reduce the transmission power of the transmission signal using the radio resource R1.

In step S211, the transceiver 110 of the radio base station BS1 performs data transmission to the radio terminal UE2 by using the radio resource R1 allocated to the radio terminal UE2.

In step S212, the radio base station BS2 performs data transmission to the radio terminal UE1 by using the radio resource R1.

In step S213, the channel quality measurement unit 122 of the radio base station BS1 measures the channel quality Q1 again from the pilot signal 1 newly received from the radio terminal UE1.

In step S214, the radio base station BS2 again measures the channel quality Q3 from the pilot signal 1 newly received from the radio terminal UE1.

In step S215, the radio base station BS2 transmits the channel quality Q3 measured in step S214 (or an index of the channel quality Q3) to the radio base station BS1 through the communications between base stations.

In step S216, the channel quality comparator 123 of the radio base station BS1 compares the channel quality Q1 measured by the channel quality measurement unit 122 in step S213 with the channel quality Q3 received from the radio base station BS2 in step S215. In this operation example, an assumption is made that the result of the comparison shows that the channel quality Q1>the channel quality Q3.

In step S217, the resource allocation unit 121 of the radio base station BS1 allocates the radio resource R1 to the radio terminal UE1 again. Note that, since the procedure to cancel CoMP is omitted, it is unnecessary to perform the setting procedure for resetting COMP.

As described above, according to this operation sequence, it is made possible to perform reallocation of the radio resource R1 without relying on the controller device 11.

### (3.2.3) Operation Sequence Example 3

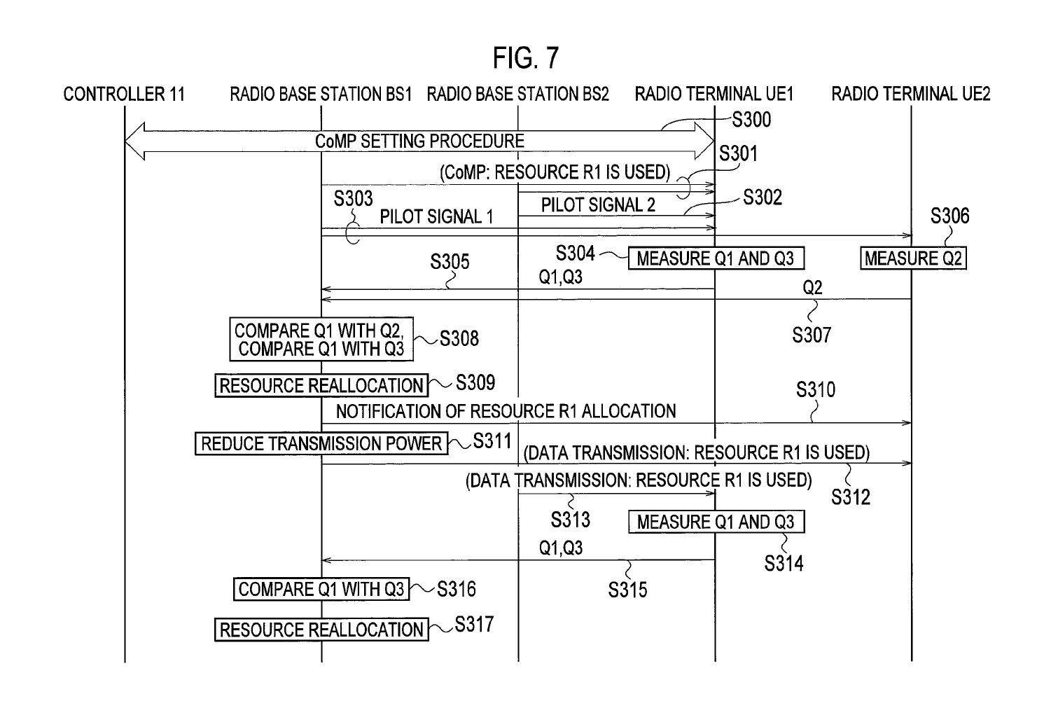

FIG. 7 is a sequence diagram showing an operation sequence example 3 of the radio communication system 1. While the radio base station BS1 and the radio base station BS2 measure the channel quality in the operation sequence examples 1 and 2 described above, the radio terminal UE1 and the radio terminal UE2 perform this measurement in this operation example.

The processing in steps S300 and 301 is executed in the same manner as in the case of steps S100 and S101 in the operation sequence example 1 described above.

In step S302, the radio base station BS2 transmits the pilot signal 2. In step S303, the base station BS1 transmits the pilot signal 1. Note that, each pilot signal is periodically transmitted thereafter.

In step S304, the radio terminal UE1 measures the channel quality Q1 from the pilot signal 1 received from the radio base station BS1 and also measures the channel quality Q3 from the pilot signal 2 received from the radio base station BS2.

In step S305, the radio terminal UE1 transmits the channel quality Q1 and the channel quality Q3 (or index thereof), which are measured in step S304, to the radio base station BS1.

In step S306, the radio terminal UE2 measures the channel quality Q2 from the pilot signal 1 received from the radio base station BS1.

In step S307, the radio terminal UE2 transmits the channel quality Q2 measured in step S306 (or an index thereof) to the radio base station BS1.

In step S308, the channel quality comparator 123 of the radio base station BS1 compares the channel quality Q1 received in step S305 and the channel quality Q2 received in step S307. In this operation example, an assumption is made that the result of the comparison shows that the channel quality Q1<<the channel quality Q2. The channel quality comparator 123 makes a comparison between the channel quality Q1 and the channel quality Q3 that are received in step S305. In this operation example, an assumption is made that the result of the comparison shows that the channel quality Q1<<the channel quality Q3.

In step S309, the resource allocation unit 121 of the radio base station BS1 allocates the radio resource R1 to the radio terminal UE2. During this processing, the procedure to cancel CoMP is omitted, and CoMP is kept set.

In step S310, the transceiver 110 of the radio base station BS1 transmits to the radio terminal UE2, an allocation notification indicating allocation of the radio resource R1.

In step S311, the transmission power controller 124 of the radio base station BS1 performs control to reduce the transmission power of the transmission signal using the radio resource R1.

In step S312, the transceiver 110 of the radio base station BS1 performs data transmission to the radio terminal UE2 by using the radio resource R1 allocated to the radio terminal UE2.

In step S313, the radio base station BS2 performs data transmission to the radio terminal UE1 by using the radio resource R1.

In step S314, the radio terminal UE1 measures the channel quality Q1 again from the pilot signal 1 newly received from the radio base station BS1 and also measures the channel quality Q3 again from the pilot signal 2 newly received from the radio base station BS2.

In step S315, the radio terminal UE1 transmits the channel quality Q1 and the channel quality Q3 measured in step S314 (or an index thereof) to the radio base station BS1.

In step S316, the channel quality comparator 123 of the radio base station BS1 compares the channel quality Q1 and the channel quality Q3 received from the radio terminal UE1 in step S315. In this operation example, an assumption is made that the result of the comparison shows that the channel quality Q1>the channel quality Q3.

In step S317, the resource allocation unit 121 of the radio base station BS1 allocates the radio resource R1 to the radio terminal UE1 again. Note that, since the procedure to cancel CoMP is omitted, it is unnecessary to perform the setting procedure for resetting COMP.

As described above, according to this operation sequence, the channel quality of the downlink can be measured. Thus, the operation sequence is effective if the duplex operation is FDD.

### (4) EFFECTS OF EMBODIMENT

As described above, according to the present embodiment, the resource allocation unit 121 of the radio base station BS1 allocates the radio resource R1 used in CoMP to the radio terminal UE2 instead of the radio terminal UE1 without performing the procedure to cancel CoMP if the channel quality Q1<<the channel quality Q3 and also if the channel quality Q1<the channel quality Q2 in CoMP of the JP scheme.

The resource allocation unit 121 of the radio base station BS1 allocates the radio resource R1 used in CoMP to the radio terminal UE2 instead of the radio terminal UE1 without performing the procedure to cancel CoMP if the radio base station BS1 is not selected and also if the channel quality Q1<the channel quality Q2 in CoMP of the CS scheme.

Accordingly, the radio resource R1 can be effectively utilized in CoMP of both of the JP scheme and the CP scheme.

While the radio base station BS1 allocates the radio resource R1 to the radio terminal UE2, the radio terminal UE1 is in a state where data is supposed to be transmitted thereto from the radio base station BS1, and a transmission signal from the radio base station BS1 to the radio terminal UE2 directly acts as an interference signal to the radio terminal UE1.

Here, the resource allocation unit 121 of the radio base station BS1 allocates the radio resource R1 to the radio terminal UE2 having a higher channel quality than the radio terminal UE1. Thus, the transmission power to the radio terminal UE2 can be suppressed to be low.

For this reason, the transmission power controller 124 of the radio base station BS1 reduces the transmission power for data transmission to the radio terminal UE2 below the transmission power for data transmission to the radio terminal UE1 after the radio resource R1 is allocated to the radio terminal UE2.

Accordingly, the signal transmitted to the radio terminal UE2 from the radio base station BS1 seems sufficiently low in the radio terminal UE1. Thus, it is possible to reduce interference from the communications between the radio base station BS1 and the radio terminal UE2 to the communications between the radio base station BS2 and the radio terminal UE1.

Even if the signal supposed to be transmitted from the radio base station BS1 to the radio terminal UE1 becomes undetectable as a result of reducing the transmission power by the radio base station BS1, the radio terminal UE1 can modulate data from the transmission signal sent from the radio base station BS2 alone. Thus, there is no problem even in this case.

In addition, according to the present embodiment, the resource allocation unit 121 of the radio base station BS1 allocates the radio resource R1 used in CoMP to the radio terminal UE2 instead of the radio terminal UE1 without taking the procedure to cancel CoMP.

If the condition that the channel quality Q1<<the channel quality Q3 no longer holds true in CoMP of the JP scheme, or the radio base station BS1 is selected in CoMP of the CS scheme, the resource allocation unit 121 of the radio base station BS1 allocates the radio resource R1 to the radio terminal UE1 again.

With the above described processing, it is made possible to temporarily allocate the radio resource R1 to the radio terminal UE2 without canceling CoMP. Thus, it is possible to avoid an increase in the processing load on the controller device 11 or the like associated with setting or cancellation of CoMP and also to avoid an increase in traffic in the backhaul network 10.

### Other Embodiments

As described above, the details of the present invention have been disclosed by using the embodiments of the present invention. However, it should not be understood that the description and drawings which constitute part of this disclosure limit the present invention. From this disclosure, various alternative embodiments, examples, and operation techniques will be easily found by those skilled in the art.

### (5.1) Modification Example 1

In the embodiment described above, the controller device 11 or the radio base station BS1 compares the channel quality Q1 with the channel quality Q3. However, a device other than the controller device 11 or the radio base station BS1 (the radio terminal UE1 or the radio base station BS2, for example) may compare the channel quality Q1 with the channel quality Q3.

### (5.2) Modification Example 2

In the embodiment described above, the radio resource R1 is allocated to the radio terminal UE2 if the channel quality Q1<<the channel quality Q3 and also if the channel quality Q1<<the channel quality Q2. However, the condition that the channel quality Q1<<the channel quality Q3 may be changed to a condition that the channel quality Q1<the channel quality Q3, and the condition that the channel quality Q1<<the channel quality Q2 may be changed to a condition that the channel quality Q1<the channel quality Q2.

### (5.3) Modification Example 3

In the embodiment described above, the radio communication system 1 has a configuration based on LTE-Advanced, but the configuration is not limited to LTE-Advanced, and the present invention is applicable to any radio communication system supporting coordinated communications.

### (5.4) Modification Example 4

In the embodiments described above, the configuration in which each of the radio base station BS1 and the radio base station BS2 performs baseband (BB) processing is described, but it is also possible to employ a configuration in which the BB processing is performed by the controller device 11. The type of radio base station reduced in size by providing a portion performing BB processing outside is referred to as a remote radio head (RRH). The RRH is mainly configured of an antenna and a radio frequency (RF) circuit.

In a case where the radio base station BS1 and the radio base station BS2 are each configured of an RRH, the radio base station BS1 and the radio base station BS2 are each connected to the controller device 11 via an optical fiber line or the like. The controller device 11 transmits and receives a BB signal to and from each of the radio base station BS1 and the radio base station BS2 via the optical fiber line or the like.

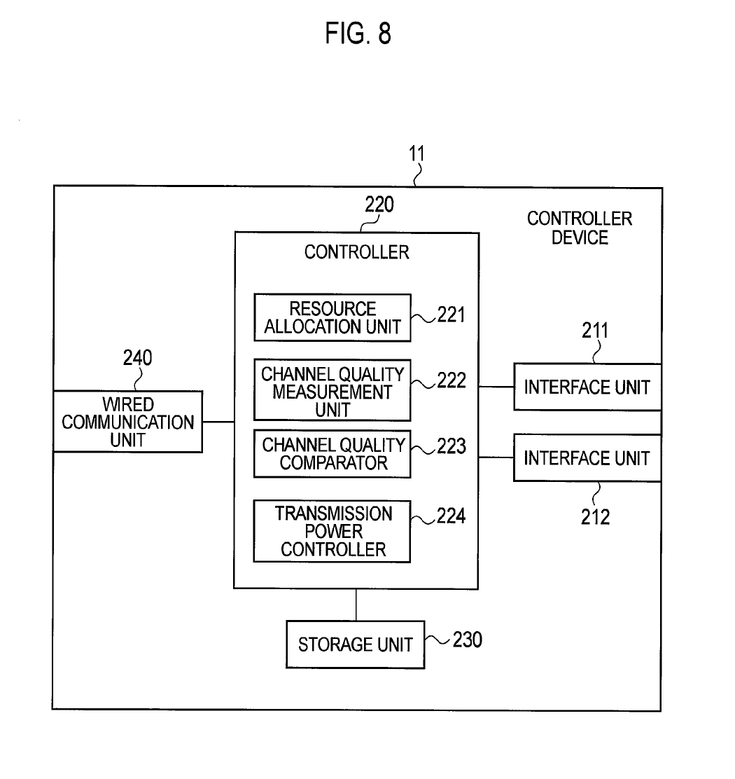

FIG. 8 is a block diagram showing the configuration of the controller device 11 in the case where the radio base station BS1 and the radio base station BS2 are each configured of an RRH. As shown in FIG. 8, the controller device 11 includes an interface unit 211, an interface unit 212, a controller 220, a storage unit 230 and a wired communication unit 240.

The interface unit 211 is configured using a BB circuit or the like and functions as an interface with the radio base station BS1. The interface unit 212 is configured using a BB circuit or the like and functions as an interface with the radio base station BS2.

The controller 220 is configured using a CPU, for example, and controls various functions included in the radio base station BS1, the radio base station BS2 and the controller device 11. The storage unit 230 is configured using a memory, for example, and stores therein various types of information used in control or the like of the radio base station BS1, the radio base station BS2 and the controller device 11. The storage unit 230 and the wired communication unit 240 are connected to a backhaul network.

The controller 220 has a resource allocation unit 221, a channel quality measurement unit 222, a channel quality comparator 223 and a transmission power controller 224.

The resource allocation unit 221 controls the radio base station BS1 in such a way that the radio base station BS1 allocates the radio resource R1 to the radio terminal UE1 when the radio base station BS1 performs CoMP with the radio terminal UE1.

The channel quality measurement unit 222 measures the channel quality Q1 by using a pilot signal 1 received by the radio base station BS1 from the radio terminal UE1 and also measures the channel quality Q2 by using a pilot signal 2 received by the radio base station BS1 from the radio terminal UE2.

The channel quality comparator 223 compares the channel quality Q1 and the channel quality Q2, which are measured by the channel quality measurement unit 222, and then compares a difference between the channel quality Q1 and the channel quality Q2 with a predetermined value.

The resource allocation unit 221 controls the radio base station BS1 in such a way that the radio base station BS1 allocates the radio resource R1 to the radio terminal UE2 instead of the radio terminal UE1 if the predetermined condition indicating that the contribution of the radio base station BS1 to CoMP is lower than a predetermined degree is satisfied and also if the channel quality Q2 is higher than the channel quality Q1. The resource allocation unit 221 preferably controls the radio base station BS1 in such a way that the radio base station BS1 allocates the radio resource R1 to the radio terminal UE2 instead of the radio terminal UE1 if the predetermined condition indicating that the contribution of the radio base station BS1 to CoMP is lower than a predetermined degree is satisfied and also if the channel quality Q2 is higher than the channel quality Q1 by an amount equal to or greater than a predetermined value (threshold 1). Here, the allocation of the radio resource R1 to the radio terminal UE2 is performed without taking the procedure to cancel CoMP.

Here, the predetermined condition is any one of (a) to (c) below, for example.
(a) In CoMP of the JP scheme, the channel quality Q1 is lower than the channel quality Q3 and also the difference between the channel quality Q1 and the channel quality Q3 is equal to or greater than a predetermined value (threshold 2). Note that, the lower limit of the threshold 2 may be set as a value of the channel quality Q3 of a case where the radio terminal UE1 is capable of demodulating data by using a transmission signal from the radio base station BS2 alone.
(b) In CoMP of the CS scheme, the radio base station BS1 is not selected.
(c) In CoMP of the JP scheme or the CS scheme, there is no transmission data to be transmitted to the radio terminal UE1 by the radio base station BS1 by using the radio resource R1.

The transmission power controller 224 controls a transmission power for data transmission performed by the radio base station BS1. If the resource allocation unit 221 allocates the radio resource R1 to the radio terminal UE2 instead of the radio terminal UE1, the transmission power controller 224 controls the radio base station BS1 in such a way that the radio base station BS1 reduces the transmission power used in data transmission to the radio terminal UE2 to be lower than the transmission power used in data transmission to the radio terminal UE1.

The resource allocation unit 221 controls the radio base station BS1 in such a way that the radio base station BS1 allocates the radio resource R1 to the radio terminal UE1 again if the predetermined condition described above becomes no longer satisfied after the radio resource R1 is allocated to the radio terminal UE2.

As described above, the present invention naturally includes various embodiments which are not described herein. Accordingly, the technical scope of the present invention should be determined only by the matters to define the invention in the scope of claims regarded as appropriate based on the description.

Entire contents of Japanese Patent Application Publication 2009-151662 (filed Jun. 25, 2009) are herein incorporated by reference.

### INDUSTRIAL APPLICABILITY

As described above, with the radio communication system, the radio base station and the radio communication method according to the present invention, it is possible to effectively utilize a radio resource used in coordinated communications. Thus, the radio communication system, the radio base station and the radio communication method are useful in radio communications such as mobile communications.

1. A radio communication system comprising:
a first radio terminal;
a second radio terminal;
a first radio base station configured to allocate, to the first radio terminal, a radio resource specified by a combination of frequency and time; and
a second radio base station configured to allocate, to the first radio terminal, the same radio resource as the radio resource, wherein
the first radio base station and the second radio base station perform coordinated communications with the first radio terminal by using the radio resource, and
the first radio base station allocates the radio resource to the second radio terminal instead of the first radio terminal if a predetermined condition indicating that contribution of the first radio base station to the coordinated communications is lower than a predetermined degree is satisfied and also if a second channel quality between the first radio base station and the second radio terminal is higher than a first channel quality between the first radio base station and the first radio terminal.

2. A radio base station comprising a resource allocation unit configured to allocate a radio resource specified by a combination of frequency and time to a radio terminal, the radio base station configured to perform coordinated communications with the radio terminal together with a different radio base station configured to allocate the same radio resource as the radio resource to the radio terminal, wherein
the resource allocation unit allocates the radio resource to a different radio terminal instead of the radio terminal if a predetermined condition indicating that contribution of the radio base station to the coordinated communications is lower than a predetermined degree is satisfied and also if a second channel quality between the radio base station and the different radio terminal is higher than a first channel quality between the radio base station and the radio terminal.

3. The radio base station according to claim 2, wherein
the predetermined condition is that the first channel quality is lower than a third channel quality between the different radio base station and the radio terminal.

4. The radio base station according to claim 3, wherein
the predetermined condition is that the first channel quality is lower than the third channel quality while a difference between the first channel quality and the third channel quality is equal to or greater than a predetermined value.

5. The radio base station according to claim 2, wherein
the predetermined condition is that the radio base station is not selected in the coordinated communications using a scheme in which any selected one of the radio base station and the different radio base station performs data transmission to the radio terminal.

6. The radio base station according to claim 2, wherein
the predetermined condition is a condition that there is no data to be transmitted and received by the radio base station to and from the radio terminal.

7. The radio base station according to claim 2, wherein
the resource allocation unit allocates the radio resource to the radio terminal again if the predetermined condition is no longer satisfied.

8. The radio base station according to claim 2, further comprising:
a transmitter configured to perform data transmission by using the radio resource; and
a transmission power controller configured to control a transmission power for data transmission performed by the transmitter, wherein
the resource allocation unit allocates the radio resource to the different radio terminal instead of the radio terminal if the predetermined condition is satisfied, if the second channel quality is higher than the first channel quality, and also if a difference between the first channel quality and the second channel quality is equal to or greater than a predetermined value, and
the transmission power controller reduces a transmission power for data transmission to the different radio terminal below a transmission power for data transmission to the radio terminal if the resource allocation unit allocates the radio resource to the different radio terminal instead of the radio terminal.

9. The radio base station according to claim 2, wherein the resource allocation unit allocates the radio resource to the different radio terminal instead of the radio terminal without taking a procedure to cancel the coordinated communications if the predetermined condition is satisfied and also if the second channel quality is higher than the first channel quality.

10. A radio communication method comprising the steps of:
allocating a radio resource specified by a combination of frequency and time to a first radio terminal by a first radio base station;
allocating the same radio resource as the radio resource to the first radio terminal by a second radio base station;
performing coordinated communications with the first radio terminal by using the radio resource by the first radio base station and the second radio base station; and
allocating the radio resource to the second radio terminal instead of the first radio terminal by the first radio base station w if a predetermined condition indicating that contribution of the first radio base station to the coordinated communications is lower than a predetermined degree is satisfied and also if a second channel quality between the first radio base station and the second radio terminal is higher than a first channel quality between the first radio base station and the first radio terminal.
